(19) United States
(12) Patent Application Publication
(10) Pub. No.: US 2005/0017136 A1
(43) Pub. Date: Jan. 27, 2005

(54) Tripod support stand

(76) Inventors: Necia D. Bower, Lake Forest, CA (US); Peter Heller, San Clemente, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/626,750

(22) Filed: Jul. 23, 2003

(51) Int. Cl. F16M 11/00

(52) U.S. Cl. 248/163.2; 248/165; 248/97

(57) ABSTRACT

A tripod support apparatus comprises an open collar having three leg receivers extending outwardly from the collar in spaced apart positions. Each of three support legs is removably engaged with one of the leg receivers at an upper end, with the support legs depending downwardly from the leg receivers, thereby supporting the open collar at a desired position above a support surface. A leg brace assembly engages the support legs medially so as to brace the support legs in a downwardly divergent stance. With the legs disengaged from the collar, the brace assembly is able to be folded to allow the three legs to assume positions in a common plane for shipping, storage and improved portability.

### BACKGROUND OF THE INVENTION

INCORPORATION BY REFERENCE: Applicant(s) hereby incorporate herein by reference, any and all U.S. patents, U.S. patent applications, and other documents and printed matter cited or referred to in this application.

1. Field of the Invention

This invention relates generally to stands for flower arrangements and the like, and more particularly to a tripod flower stand having snap-in legs joined to a collar for receiving a flower pot and in which the legs may be removed from the collar and folded flat.

2. Description of Related Art

There is a need for a collapsible stand for the support of floral pots at functions such as parties, weddings, funerals and the like. A florist is limited in carrying assembled floral stands due to a lack of space in a transport vehicle. Also, it is desirable to have a stand that can be broken down for storage and reuse, or which is inexpensive enough to discard after one use.

The following art defines the present state of this field:

Saxon et al is a published application, U.S. 2002/0078624, teaching a tree support which holds the tree in the desired orientation until its root system can hold the tree in that orientation without the need for additional support. The tree support includes a collar and three or more legs. Positioning screws carried by the collar advance radially inward toward the trunk of the tree to engage the trunk and thereby hold the collar in place. The outer ends of the positioning screws are capped with ornamental medallions. The medallions can carry any design or, for example, initials or information about the tree. One embodiment of leg for the tree stand, is a telescoping, rigid leg that pushes against movement of the tree away from normal orientation. The other embodiment of the leg uses tension on wires connected to anchor screws inserted into the ground to hold the tree upright.

Herbolsheimer, U.S. Pat. No. 2,474,668, teaches a stool with a seat peripheral down turned flange with inset portions constituting stirrups and an interior annular channel in its lower part. Legs support the seat and the upper portions of each leg have side flanges providing stops. A tongue extends upwardly beyond the stops and an exterior transverse bead is located below the stops.

Strople et al, U.S. Pat. No. 2,504,902, teaches a stand for supporting flower pots with a pair of leg sections having a pair of spaced diametrically opposed legs and an upper and lower brace extending from one leg to the other held fast at opposite ends to the respective opposed legs.

Gits, U.S. Pat. No. 3,604,677, teaches a holder for large bags having a flexible liner strip with ends fastened together to form a wide-mouthed hoop and two leg members having sheperd's crook bent ends for enclampingly receiving the hoop.

Gallo, U.S. Pat. No. 3,076,290, teaches a flower pot assembly providing a plurality of similarly formed flower pots arranged in tiers in spaced relation one above the other on the same vertical axis. Legs snap onto the pots and provide a means for mounting on the rim of the pot below.

Grunlund, U.S. Pat. No. 1,164,714, teaches a stand having a body with two semicircular members with abutting ends with downwardly extending ears pivoted together forming vertically abutting walls, horizontally arranged sockets carried by lower faces and vertically depending flanges between the sockets. Legs are engaged in the sockets for supporting a pot or vase.

Testa, U.S. Pat. No. 2,850,826, teaches a floral stand with an upper horizontal wire ring, wires within and across the ring reinforcing it, a lower horizontal wire ring, and three V-shaped mutually divergent long legs formed of bent wire.

Rothermel, U.S. Pat. No. 1,830,769, teaches a vase holder having a ring mounted on three legs, the ring formed from a unitary metallic strip with overlapping ends having coextensive slots.

Bindon, U.S. Pat. No. 1,615,611 teaches a vase with a toke encircling the vase and plural legs attached to the yoke and a means for connecting the legs in an adjusted position.

Cordley, U.S. Pat. No. 1,015,615, teaches a water cooler stand with a ring adapted to support a water cooler on plural legs, the upper ends of which are bent into contact with the ring. A brace member connects the legs. The assembly is screwed together.

Bonomo, U.S. Pat. No. 5,499,787 teaches a bag holder for supporting an open-ended bag of flexible material in position for filling, comprising a plurality of separate segments configured to be releasably joined together to form a ring member having an external, bag contacting surface. Legs are provided for supporting the ring member in a substantially horizontal attitude slightly above ground level. Each of the separate segments constituting the ring member is essentially flat and of elongate, slightly curved construction, with each segment having first and second ends equipped with joinder devices that are able to be readily interfitted. The first end of a first segment is joinable with the second end of a second segment, and the first end of the second segment is joinable with the second end of a third segment, with such Joinder of first and second ends of the segments continuing until the completed ring member of sturdy construction is defined. Advantageously, the completed ring member presents an external surface that slopes outwardly and downwardly, over which external surface the open end of the flexible bag can be extended. A suitable tension-applying device surrounds the external surface of the ring member for holding the flexible bag in a tight, non-slip relationship to the external surface of the ring member. Because the segments are releasably joined together, they can be readily separated after use, and stored in a flat container.

Johnson, U.S. Pat. No. 4,899,967, teaches a readily assembled and disassembled portable flexible bag holder comprising an annular member having an annular recess formed in its outer peripheral surface and a partially inflated air impervious flexible annular tubular member seated in the annular recess and having an annular contacting relationship therewith. A plurality of arcuate members are provided for contacting a portion of the open end portion of a flexible bag that has been stretched over the annular member and the air impervious flexible annular tubular member. A plurality of clamps are provided to urge each of the arcuate members in radially inward directions to clamp a portion of the open end portion of the flexible bag between each of the arcuate members and a radially opposite portion of the air impervious flexible tubular annular member. A leg is removably secured to each of the arcuate members for holding the open end portion of the flexible bag a distance above a support surface.

Zimmerman, U.S. Pat. No. 5,375,370, teaches a plate symmetrically oriented about an axis, having a plurality of annular arrays of openings directed through the plate, with the openings of adjacent annular arrays offset relative to one another to each permit reception of individual flower stems through the guide plate, with the guide plate having support legs removably mounted thereto and permitting positioning of the guide plate within a container for the support of flowers and the like.

Hendrix et al, U.S. Pat. No. 5,996,813 teaches a flower arrangement stand with multiple work station blocks for maintaining pew and bouquet holders stable while making up flower arrangements using the holders.

Cheng, U.S. D384222, teaches a design for a plant stand.

Chipman, U.S. D422390 teaches a design for a receptacle frame.

Cardelli, U.S. D133368, teaches a design for a flowerpot and holder.

Our prior art search with abstracts described above teaches a bag holder, furniture, a collapsible flower stand, an adjustable and collapsible stand, flower pots, a floral stand, a tree support, a collapsible holder for thin plastic bags utilizing a non-slip tightening means, a pot or vase holder, a vase, a portable flexible bag holder, a trash bag support with collapsible legs, a water cooler stand, a flower arrangement holder, an assembly stand for wedding bouquets and pew holders, a combined flow pot and holder therefor, a plant stand, and a receptacle frame, but does not teach a tripod type collar support for a flower arrangement or similar items with snap-in legs and V-shaped let in slot arrangement. The present invention fulfills these needs and provides further related advantages as described in the following summary.

### SUMMARY OF THE INVENTION

The present invention teaches certain benefits in construction and use which give rise to the objectives described below.

There is a need for a The present invention is a tripod support apparatus comprising an open collar having three leg receivers extending outwardly from the collar in spaced apart positions. Each of three support legs is removably engaged with one of the leg receivers at an upper end thereof, with the support legs depending downwardly from the leg receivers, thereby supporting the open collar at a desired position above a support surface. A leg brace assembly engages the support legs medially so as to brace the support legs in a downwardly divergent stance. With the legs disengaged from the open collar, the brace assembly is folded to allow the three legs to assume positions in a common plane, compactly arranged for shipping, storage and portability.

A primary objective of the present invention is to provide an apparatus and method of use of such apparatus that provides advantages not taught by the prior art.

Another objective is to provide such an invention capable of rigid support of a flower arrangement.

A further objective is to provide such an invention capable of low cost in manufacture so that the invention may be considered as disposable.

A still further objective is to provide such an invention capable of folding compactly for storage or shipping.

A yet further objective is to provide such an invention capable of being made of light weight structural materials.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the invention;

FIG. 2 is a close up exploded partial view thereof;

FIG. 3 is a close up partial view thereof as assembled; and

FIG. 4 is a frontal perspective view showing tripod legs of one embodiment of the invention arranged compactly as folded.

### DETAILED DESCRIPTION OF THE INVENTION

The above described drawing figures illustrate the invention in at least one of its preferred embodiments, which is further defined in detail in the following description.

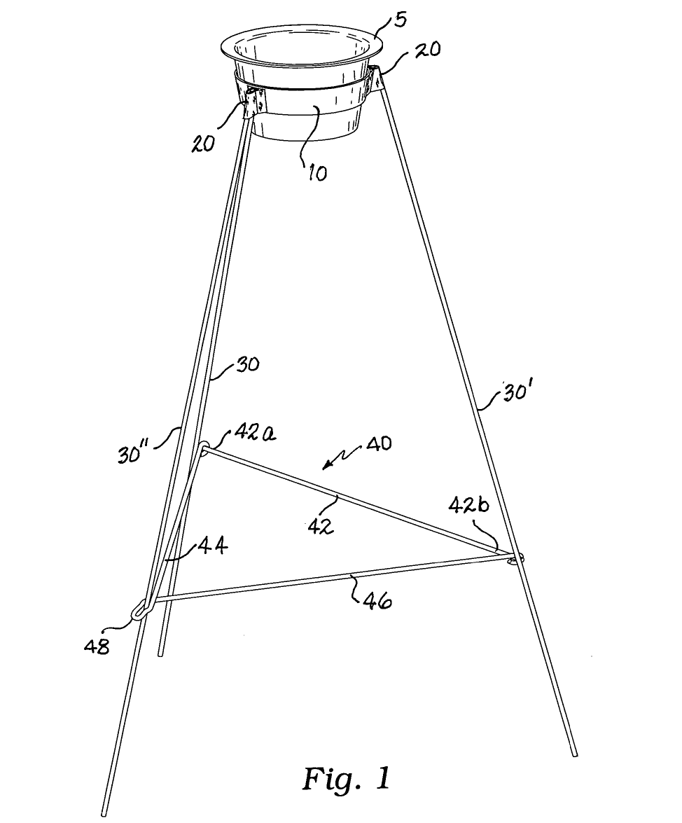

The present invention, as shown in FIG. 1, is a flower arrangement support apparatus with preferably three legs, i.e., a tripod support arrangement. The preferred application for the support apparatus is for flower arrangements used at weddings and funerals. However, the present apparatus may be used in a very wide range of applications including the support of art objects and the like. The invention will be described as a tripod device, but it should be recognized that more than three legs may be used in a manner quite similar to that described.

An open collar 10, of molded plastic or sheet metal construction provides an inner annular surface that is convergent downward at a slight angle so as to take the tapered shaped of a flower pot or vessel. The collar includes three leg receivers 20 positioned radially and extending outwardly in spaced apart positions separated by 120 angular degrees around the open collar 10. Three identical elongate support legs 30, 30′ and 30″ are removably engaged with the leg receivers 20, each at an upper proximal end of the support legs 30, 30′ and 30″, so that the support legs 30, 30′ and 30″ depend from the open collar 10 downwardly for supporting the open collar 10 above a support surface, such as a floor (not shown). The legs are preferably made of light weight rod stock which may be about ¼ inch in diameter and about 45 inches in length. Because the legs 30, 30′ and 30″ are angled outwardly, the top of the collar is preferably positioned about 43 inches above the support surface.

A leg brace assembly 40 engages the support legs 30, 30′ and 30″ medially, the leg brace assembly 40 being configured so as to brace the support legs 30, 30′ and 30″ in a downwardly divergent stance providing lateral stability to the apparatus. The open collar 10 is of a size, between about 7 to 9 inches in diameter, for accepting a flower pot 5 or other fixture (not part of the invention).

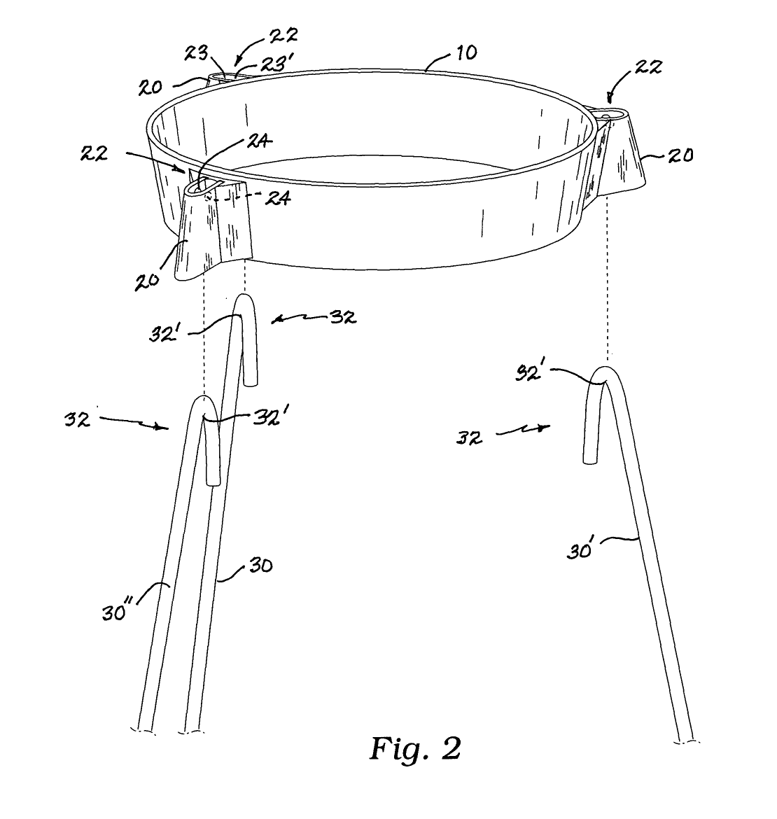

Each of the leg receivers 20 provides a vertical slot 22, and each one of the slots 22 provides opposing inner sidewall surfaces 23 and 23′. Either one or both of the sidewall surfaces 23, 23′ further provides at least one protrusion 24 such as a bump with rounded outer surface, extending away from either one of the sidewall surfaces 23, 23′ toward the other of the sidewall surfaces. In other words, the invention may have one bump 24 or plural bumps 24 and the bump(s) may extend from one or both of the sidewall surfaces 23, 23′ toward the other of the sidewall surfaces 23, 23′. This is clearly shown in FIG. 2.

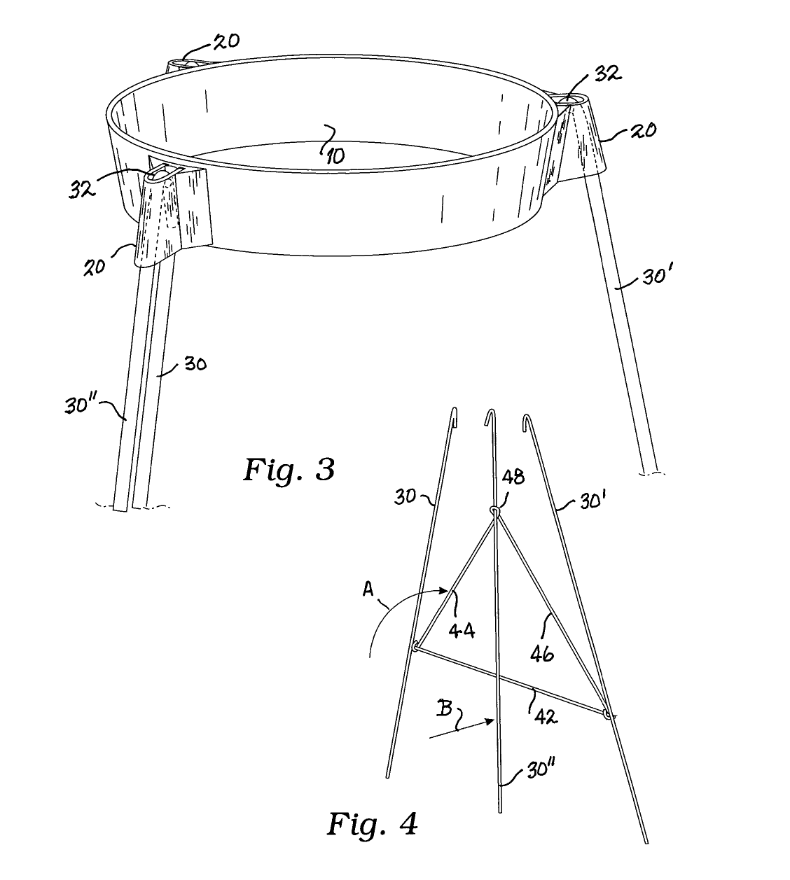

As clearly shown in FIG. 2, the upper proximal end of each of the support legs 30, 30′ and 30″ is formed into an inverted V-shaped configuration by tightly bending the rod stock; this is identified by numeral 32. The vertical slots 22 of the leg receivers 20 each converge upwardly for accepting the V-shaped configuration 32 of the support legs 30, 30′ and 30″ in a tight-fitting engagement so that the legs 30, 30′ and 30″ cannot easily disengage from the slots 22. The V-shaped configuration 32 (actually, the rod diameter) is sized for forcefully bypassing the protrusion(s) 24 during entry into the vertical slot 22 of the receivers 20, and this is facilitated by elastic deformation or strain in the slot walls and subsequent recovery due to plastic memory. The protrusion(s) 24 thereafter is/are positioned inside an apex 32′ of the V-shaped configuration 32 of each of the support legs 30, 30′ and 30″ thereby securing the support legs 30, 30′ and 30″ in the receivers 20. This is shown in FIG. 3 and is considered a critical arrangement.

As shown in FIG. 1, the leg brace assembly 40 includes a first straight brace rod 42 fixedly joining two of the three support legs (30 and 30′) at a first and a second terminal ends 42a and 42b, of the first brace rod 42 and such joints are preferably made by welding or other means of permanent structural attachment. The leg brace assembly 40, preferably made up of long straight lengths of 1/8 inch rod stock, further comprises a second 44 and a third 46 moveable brace rods, where both of the second and third brace rods 44, 46 are loosely engaged with the first brace rod 42 at its ends 42a and 42b respectively. The ends of brace rods 44, 46 are each looped about the brace rod 42 so that rods 44, 46 are able to rotate about rod 42. Both the second and third brace rods 44, 46 loosely engages the third 30″ of the support legs in sliding engagement. Preferably this is accomplished as shown in FIG. 1 by forming the brace rods 44 and 46 from a single long portion of rod stock forming a loop 48 at their common ends, the loop encircling leg 30″. When the stand is set up as shown in FIG. 1, the loop 48 holds the third support leg 30″ in a fixed juxtaposition relative to the other support legs, i.e., rods 42, 44 and 46 are all arranged horizontally and restrain the legs 30, 30′ and 30″ in a preferred stable tripod stance.

As shown in FIG. 4, once removed from open collar 10, legs 30 and 30′ and brace rod 42 may be held in a fixed position while brace rods 44 and 46 are pivoted together upwardly, loop 48 being large enough to allow this, as shown by arrow “A,” while leg 30″ is moved toward rod 42, as shown by arrow “B.” Thus, legs 30, 30′ and 30″ are all able to be placed into roughly the same plane, i.e., flat for compact storage, shipping and portability.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A support apparatus comprising: a collar having at least three leg receivers positioned in extending outwardly spaced apart positions around the collar: at least three elongate support legs, each of the support legs removably engaged within a slot in one of the leg receivers at an upper proximal end of the support leg, the support legs depending divergently downwardly from the leg receivers for supporting the open collar above a support surface; and a leg brace assembly engaging the support legs medially, the leg brace assembly configured so as to rotate for placing the support legs in a common plane for compact storage; wherein, an upper proximal end of each of the support legs is formed as an inverted V-shape, the slots of the leg receivers each converging upwardly for accepting the V-shape of the support legs in tight-fitting engagement.

2. The apparatus of claim 1 wherein the slots provide opposing inner sidewall surfaces, at least one of the sidewall surfaces providing at least one protrusion positioned for snap-in engagement of the support leg.

3. The apparatus of claim 2 wherein an upper proximal end of each of the support legs is formed as an inverted V-shape, the slots of the leg receivers each converging upwardly for accepting the V-shape of the support leas in tight-fitting engagement.

4. The apparatus of claim 1 wherein the support legs are sized for forcefully bypassing the protrusions during entry into the vertical slots of the receivers, the protrusions thereafter positioned inside an apex of the V-shape of the support legs thereby securing the support legs in the receivers.

5. The apparatus of claim 1 wherein the at least three elongate support legs comprise exactly three support legs; the leg brace assembly comprising a first brace rod fixedly joining two of the three support legs at a first and a second terminal ends of the first brace rod, the leg brace assembly further comprising a second and a third moveable brace rods, each of the second and third brace rods loosely engaging one of the first and the second terminal ends of the first brace rod and each of the second and third brace rods loosely engaging the third of the three support legs in sliding engagement.

6. A method of use of a flower arrangement support apparatus, the method comprising the steps of: engaging elongate support legs in slots of leg receivers of a collar and depending the legs downwardly from the collar in off-vertical divergent positions; attaching a first horizontal brace rod of a leg brace assembly medially between two of the support logs; engaging a second and a third brace rods rotationally at ends of the first brace rod; engaging a common end of the second and third brace rods slidingly with a third of the support legs for stable display of the flower arrangement; and for compact storage, removing the collar from the support legs, rotating the second and the third brace rods vertically and simultaneously drawing the third of the support legs and the second and third brace rods into a plane common with the first and second legs and the first brace rod.
